(19) United States
(12) Patent Application Publication
(10) Pub. No.: US 2004/0118294 A1
(43) Pub. Date: Jun. 24, 2004

(54) Semiautomated coffee maker

(76) Inventor: Wade L. Grassedonio, Corpus Christi, TX (US)

Correspondence Address: G. Turner Moller, Suite 720, 711 North Carancahua, Corpus Christi, TX, 78475, US

(21) Appl. No.: 10/324,520

(22) Filed: Dec. 19, 2002

(51) Int. Cl. A23F 3/00

(52) U.S. Cl. 99/279

(57) ABSTRACT

A coffee maker includes a tray having multiple compartments into which ground coffee is placed. The tray is moved relative to a water source so the compartments are sequentially placed in a position to receive water in a brewing cycle so a number of pots of coffee can be brewed, one after another, with minimal intervention by the user. When the coffee maker is loaded, the only requirement of the user is to empty the old pot. In the event the old pot is not emptied, a weight sensor disables the coffee maker. In a preferred embodiment, the tray is a lazy Susan arrangement which is rotated about a central axis to present a new batch of ground coffee to a water source. In other embodiments, a water source is moved to a brewing location over successive coffee containing compartments or a plurality of water spigots are separately controlled for delivering hot water to successive coffee containing compartments.

This invention is a coffee maker and, more particularly, a coffee maker having the capability of making multiple pots of coffee with minimal intervention by the user.

### BACKGROUND OF THE INVENTION

In order to make a single pot of fresh coffee, consumer type coffee makers require the user to empty the old pot, remove and discard the old coffee grounds, rinse the filter holder, put in a new filter, measure the desired amount of coffee into the filter, pour a new batch of water into the coffee maker and operate a switch to turn the coffee maker on. For quite some time, consumer type coffee makers have been available that will turn on in response to a timer so the consumer can have a fresh pot of coffee at a predetermined time, usually in the morning, meaning that at least one of the necessary steps in coffee making has been automated. Typically, these type consumer coffee makers require the user to fill the coffee maker with water, remove and discard old coffee grounds, install a new filter, measure the appropriate amount of coffee into the new filter and set the timer.

Commercial type coffee makers are typically automated only to the extent of having a water source permanently connected to the coffee maker so starting a brewing cycle activates a valve that delivers water to the coffee maker. Otherwise, substantially the same steps are necessary to start a brewing cycle as in a sophisticated consumer model coffee maker.

A third category of coffee makers are aimed at business offices and, in terms of complexity, cost and automation, are between commercial and consumer type coffee makers.

Disclosures of interest relative to this invention are found in U.S. Pat. Nos. 2,868,109; 4,468,406; 4,566,802; 5,001,969; 5,463,932; 5,568,763; 5,676,040 and 6,155,158.

### SUMMARY OF THE INVENTION

In this invention, a coffee maker is provided that has the capability of making a series of pots of coffee with minimal intervention by the user. The coffee maker includes a series of compartments for receiving ground coffee and a water source arranged to deliver water to one of the compartments to make a pot of coffee and, after that pot is consumed, to another compartment having a supply of ground coffee to make another pot of coffee. The only required activity of the user is to empty the pot.

A control circuit is provided to control the coffee maker and provides several modes of operation. One mode of operation is to make a fresh pot of coffee at a predetermined time each day or at prescribed times on different days. An override capability is provided to make a pot of coffee at other than the predetermined times. In the event the pot is not empty, the coffee maker doesn't operate to make a new batch as this would cause the pot to overflow. Another mode of operation is to make a new pot of coffee each time the old pot is empty, as may be desirable in a business office where workers are often quick to take the last cup of coffee and reluctant to do what is necessary to start a new brewing cycle.

It is an object of this invention to provide an improved coffee maker.

A further object of this invention is to provide a coffee maker which is operated in an automated fashion to produce sequential pots of coffee.

A more specific object of this invention is to provide an automated coffee maker which is capable of making a series of pots of coffee without intervention by the user.

These and other objects and advantages of this invention will become more apparent as this description proceeds, reference being made to the accompanying drawings and appended claims.

### BRIEF DESCRIPTION OF THE DRAWINGS

FIG. 1 is a side elevational view of a coffee maker of this invention;

FIG. 2 is an isometric view of an assembly of the coffee maker of this invention that heats the water and provides a heated station for receiving a coffee pot;

FIG. 3 is an isometric view similar to FIG. 2 showing a rotatable coffee holding assembly on top of the assembly of FIG. 2;

FIG. 4 is an isometric view of a water dispensing spout showing its cooperation with a trap door on the rotatable coffee holding assembly;

FIG. 5 is a schematic view showing parts of the coffee maker of FIGS. 1-4 and a control circuit for operating the coffee maker of this invention;

FIG. 6 is a diagram showing a flow chart depicting various modes of operation of this invention;

FIG. 7 is a view similar to FIG. 1 showing another embodiment of this invention, a part of the back being broken away for clarity of illustration;

FIG. 8 is an isometric View of a water tank used in the embodiment of FIG. 7;

FIG. 9 is an isometric view of a water heating assembly similar to FIG. 2 placed in the water tank of FIG. 8;

FIG. 10 is an isometric view of the coffee maker of FIGS. 7-9 with the rotatable coffee holding assembly in place;

FIG. 11 is an isometric view similar to FIG. 10 showing the water delivery conduit in position;

FIG. 12 is an isometric view of a water pump used in the embodiment of FIGS. 7-11;

FIG. 13 is a schematic view of another embodiment of this invention;

FIG. 14 is a schematic view of another embodiment of this invention; and

FIG. 15 is a schematic view of still another embodiment of this invention.

### DETAILED DESCRIPTION

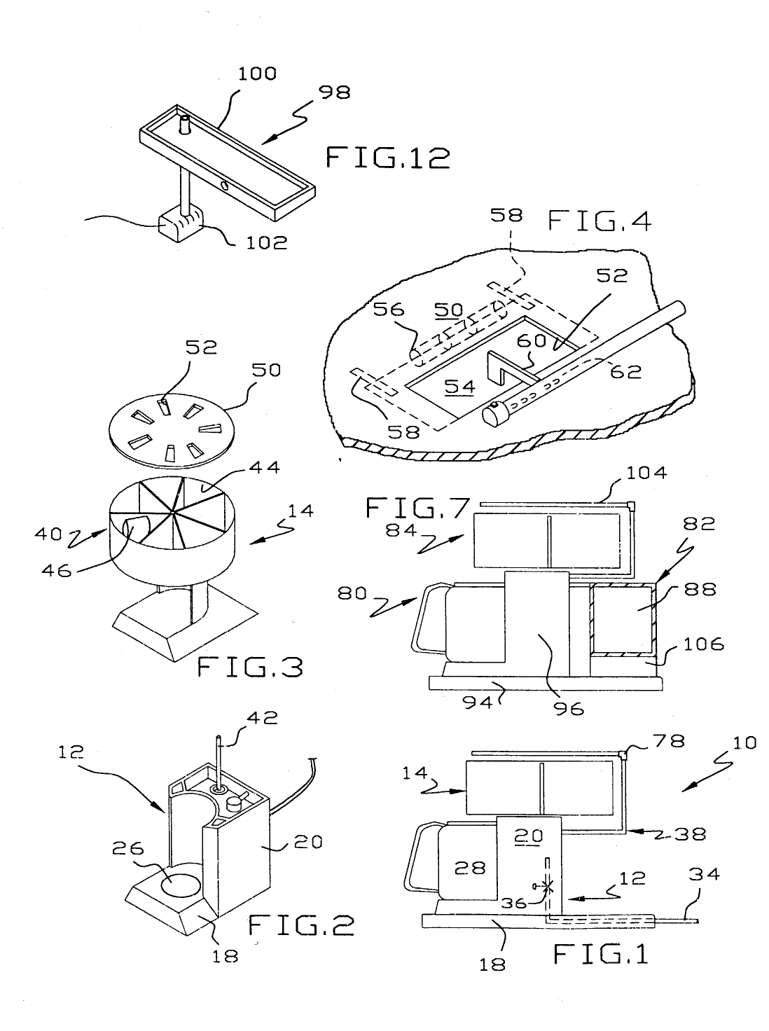

Referring to FIGS. 1-6, there is illustrated a coffee maker 10 of this invention comprising, as major components, a water handling assembly 12, a coffee receiving assembly 14 and a control circuit 16 (FIG. 5) providing various modes of operations. The water handling assembly 12 is similar to that found in prior art coffee makers such as is available from Signature Brands, Inc. of Glenwillow, Ohio under the trademark MR. COFFEE in the sense that it accepts a predetermined amount of water from a source, heats the water to a brewing temperature, and delivers the water to ground coffee.

To these ends, the water handling assembly 12 comprises a base 18 having an upright housing 20 inside of which is an assembly 22 for heating water and a container 24 for receiving a quantity of water from a source. Water from the container 24 passes into a tray (not shown) of the heating assembly 22 where the water is heated. Heated water in the assembly 22 produces steam bubbles which propel the hot water in a conventional manner to the coffee receiving assembly 14. The heating assembly 22 is of any suitable design such as is currently provided in conventional coffee makers. A hot plate or heated station 26 is provided to receive a coffee pot 28 and maintain coffee in the pot at a drinkable temperature as is well known in the art. As shown in FIG. 5, the plate 26 is heated by an electrically resistive element 30. The temperature of the plate 26 and the temperature of the heating assembly 22 are controlled in any suitable manner, such as by a temperature sensitive switches 32 or other suitable devices.

A water source 34 comprises a conduit connected to a suitable water supply in the building in which the coffee maker 10 is located and is controlled by a solenoid valve 36 inside the housing 20. In response to beginning a brewing cycle, water passes through the valve 36 into the compartment 24 in the housing 20 and then into heating assembly 22. When the water in the assembly 22 reaches brewing temperature, steam bubbles are produced which propel the hot water through an outlet conduit 38 into the coffee receiving assembly 14 and then into the coffee pot 28 as will be more fully apparent hereinafter. It will accordingly be seen that water is supplied to the coffee maker 10 through the source 34, heated, and then delivered to the outlet conduit 38 in response to commands from the control circuit 16. The outlet conduit 38 may be routed from the heating assembly 22 to the coffee receiving assembly 14 in any suitable manner.

The coffee receiving assembly 14 comprises a lazy Susan type tray 40 supported and mounted for rotation by a spindle 42 so compartments 44 provided by the tray 40 are advanced to a brewing position under the opening of the conduit 38 and at a location where the compartment being supplied with hot water drains into the coffee pot 28. As will be more fully apparent hereinafter, the compartments 44 are loaded by the user with ground coffee, either in separate filter baskets or in filter paper pouches 46. The spindle 42 is rotated by an electric motor 48 inside the housing 20 and controlled by the circuit 16 as shown in FIG. 5.

The top of the tray 40 is closed by a cover 50 having a series of openings 52 corresponding to the compartments 44 as shown in FIGS. 3-4. The cover 50 is releasably secured to the tray 40 in any suitable manner so each opening 52 registers with a single compartment 44. Each opening 52 is normally closed by a flap or closure 54 mounted by a pivot connection 56 for movement between a normal position abutting the cover 50 and a position away from the cover 50 to allow water from the outlet conduit 38 to flow through the opening 52 into the compartment 44 below. The closure 54 is biased against the cover 50 by one or more springs 58 which are illustrated as being simple leaf springs.

The closure 54 is opened, in any suitable manner, before the delivery of water through the conduit 38. The closure 54 is preferably opened in response to rotation of the tray 40 at the onset of a brewing cycle. To this end, a follower 60 extends upwardly from the closure 54 to engage the conduit 38 and thereby cam the closure 54 downwardly as the tray 40 rotates to a position where the opening 52 is immediately below one or more outlet openings 62 in the underside of the conduit 38 near the end thereof.

Referring to FIG. 5, the control circuit 16 includes a controller 64 arranged to control operation of the coffee maker 10 and cause each of the powered components of the coffee maker 10 to operated in a desired sequence. The controller 64 accordingly comprises suitable electronic controls, relays, memory, logic chips and an on-off switch 65 as will be apparent to those skilled in the art. An important part of the controller 64 is a weight sensor 66 set to detect whether the coffee pot 28 is present and empty. The controller 64 has the ability to accommodate operation of the coffee maker 10 in a variety of modes as shown by the flow diagram of FIG. 6. The controller 64 accordingly has a face plate 68 exposing at least one input device and preferably three actuators or buttons 70, 72, 74 providing operation in a manual mode, a programmed mode and a constant brew mode.

In the manual mode, pressing the button 70 simply starts a brewing cycle provided the weight sensor 66 determines that the coffee pot 28 is empty. If the coffee pot 28 is at least partially full, the controller 64 terminates operation of the coffee maker 10 and provides a message on a readable display 76. If the coffee pot 28 is empty, a signal is sent to the valve 36 and a quantity of water sufficient to brew one pot of coffee, usually at least four cups and preferably at least six cups, is delivered to the chamber 27. Water in the chamber 27 is admitted to the heating assembly 22 in a conventional manner.

The motor 48 is energized for a sufficient time to rotate the tray 40 to a position where the compartment 44 below the discharge openings 62 contains unused ground coffee. Typically, the motor 48 simply indexes the tray 40 by an angular amount equal to one compartment. As the tray 40 rotates beneath the conduit 38, the follower 60 runs under the conduit 38 thereby opening the closure 54 against the bias of the springs 58. Hot water from the heating assembly 22 passes through the conduit 38, through the opening 52 and into the compartment, mixing with ground coffee and passing into the pot 28 as liquid coffee, ready to drink. When the weight sensor 66 determines that the pot 28 is empty, operation of the coffee maker 10 is stopped, as by disconneting the coffee maker 10 from its power supply (not shown).

The next simplest mode of operation is the constant brew mode which is started by depressing the actuator 74. When the actuator 74 is depressed, the weight sensor 66 checks to see the pot 28 is present but empty and starts a brewing cycle. Whenever the sensor 66 determines the pot 28 is present and empty, another brewing cycle is started. The controller 64 counts the number of cycles brewed and, after brewing the number of pots allowed by the number of compartments 44 in the tray 40, terminates operation of the coffee maker 10.

The most complicated mode of operation is to program the coffee maker 10 to brew pots of coffee at predetermined times on predetermined days. To this end, the user manipulates the actuator 72 to indicate the time and day when the coffee maker 10 is to brew a pot of coffee. As shown in FIG. 6, there is a capability to modify the number of cups of coffee to be brewed on each cycle. When the first time and date programmed into the controller 64 comes up, a brewing cycle starts, provided the sensor 66 determines that the pot 28 is present but empty. After the end of each brewing cycle, the weight sensor 66 determines whether the pot 28 is empty and, if so, turns the coffee maker 10 off. Each time one of the programmed times and dates appears on an internal clock (not shown), a brewing cycle starts. In the event the user wants to brew an additional pot, the manual actuator 70 is depressed. If the pot 28 is empty at the next appointed time, another brewing cycle starts. It will accordingly be apparent that the tray 40 may be divided into as many compartments 44 as is convenient. In one version, there are seven compartments so a single pot of coffee may be made on seven consecutive days.

In order to clean the tray 40, the upper end of the conduit 38 provides a swivel 78 so the upper end of the conduit 38 may be swung away from the tray 40. The tray 40 is lifted off the spindle 42 and the spent coffee grounds in the compartments 44 discarded and the tray 40 washed and then refilled with ground coffee.

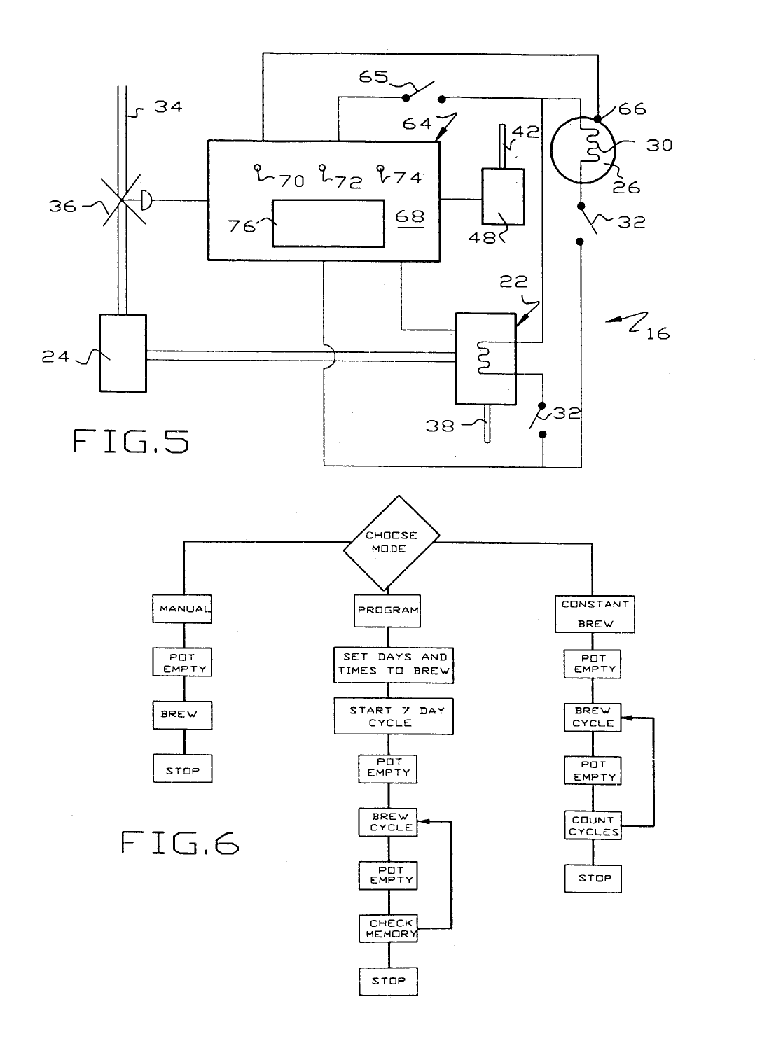

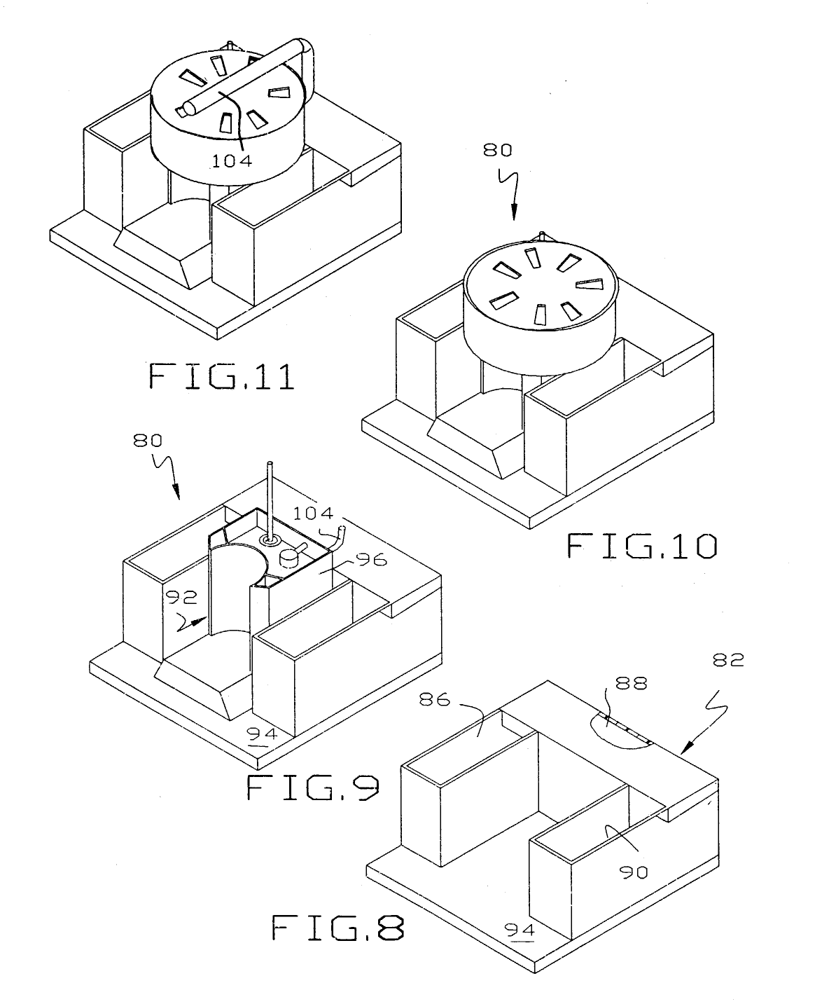

As heretofore described, the coffee maker 10 is connected to a constantly available water source, typically city water. In the event the user does not want to connect the coffee maker to a constantly available water source, the coffee maker 80 of FIGS. 7-12 provides a tank 82 of sufficient capacity to provide as many pots of coffee as there are compartments in the tray 84. The tank 82 is necessarily rather large, having a series of interconnected compartments 86, 88, 90 surrounding the water handling assembly 92 on a base 94.

The coffee maker 80 may be substantially identical to the coffee maker 10 but necessarily differs in the water handling assembly 92 because the tank 82 does not provide pressure to deliver water to the chamber inside the housing 96. Referring to FIG. 12, there is illustrated a water handling assembly 98 inside the housing 96 including a pan 100 acting as a temporary water holding compartment. The pump 102 delivers water from the tank 82 into the pan 100 where it runs by gravity into a heating assembly (not shown) inside the housing 96 where the water is heated and then delivered to an outlet conduit 104.

Accordingly, instead of the control circuit 16 controlling the amount of water delivered to the coffee maker 10 by controlling the valve 36, the control circuit controls the amount of water delivered to the outlet conduit 104 by controlling the time operation of the pump 102, or in response to the weight sensor, as will be apparent to those skilled in the art. Power to the coffee maker 10 is provided through wiring (not shown) extending through a passage or tunnel 106 under the tank 82 as shown in FIG. 7.

It is recognized there are two theoretical disadvantages of the coffee makers 10, 80. First, there may be some objection based on freshness to leave ground coffee in the compartments of the tray for extended periods before brewing. Second, there is a reduced ability to vary the amount of liquid coffee made because the amount of coffee in the compartments of tray of the embodiments of FIGS. 1-12 are loaded far in advance. The coffee maker 110 of FIG. 13 addresses both of these concerns and comprises a water handling assembly 112, a coffee handling assembly 114 including a tray 116 similar to the tray 40 of FIGS. 1-4, a coffee bean storage bin 118 and a coffee mill 120 for grinding coffee beans in response to commands from a control circuit 122.

The tray 116 includes a lid 124 providing a series of openings 126 and a closure 128 for each opening, the lid 124 and closures 128 being conveniently identical to the lid 50 and closures 54 of FIG. 4. Upon initiation of a brewing cycle, the tray 116 rotates to pass a follower (not shown) against an abutment of the coffee mill 120 to open the closure 128 beneath or otherwise in coffee receiving relation to the coffee mill 120, a door or valve 130 on the bottom of the storage bin 118 opens to deliver a quantity of beans into the coffee mill 120 which grinds the beans and delivers fresh ground coffee into the compartment 132 immediately below the mill 120.

The tray 116 indexes again in response to a command from the control circuit 122. Several things happen. As the follower (not shown) moves away from the coffee mill 120, the closure 128 moves to abut the lid 124 thereby closing the opening 126. As the lid 124 rotates further, the closure 128 of the loaded compartment 132 approaches the outlet conduit 134 so the follower (not shown) on the lid 128 abuts the conduit 134 thereby opens the closure 128 in the manner shown in FIG. 4. The tray 116 stops rotating in a position where the loaded compartment 132 is beneath the discharge openings of the outlet conduit 134. Hot water is then delivered from the water handling assembly 112 into the conduit 134 in response to a command from the control circuit 122. Hot water then passes into the loaded compartment 132 and produces a fresh pot of coffee. It will thus be seen that the tray 116 is emptied after all of the compartments have been used. The compartments of the tray 116 are loaded with freshly ground coffee only at the time a new brewing cycle is started. This also gives the coffee maker 110 the flexibility to produce pots of coffee of different capacity, e.g. four, six or eight cups, because the correct amounts of water and ground coffee can be delivered to the compartments in response to commands from the control circuit 122.

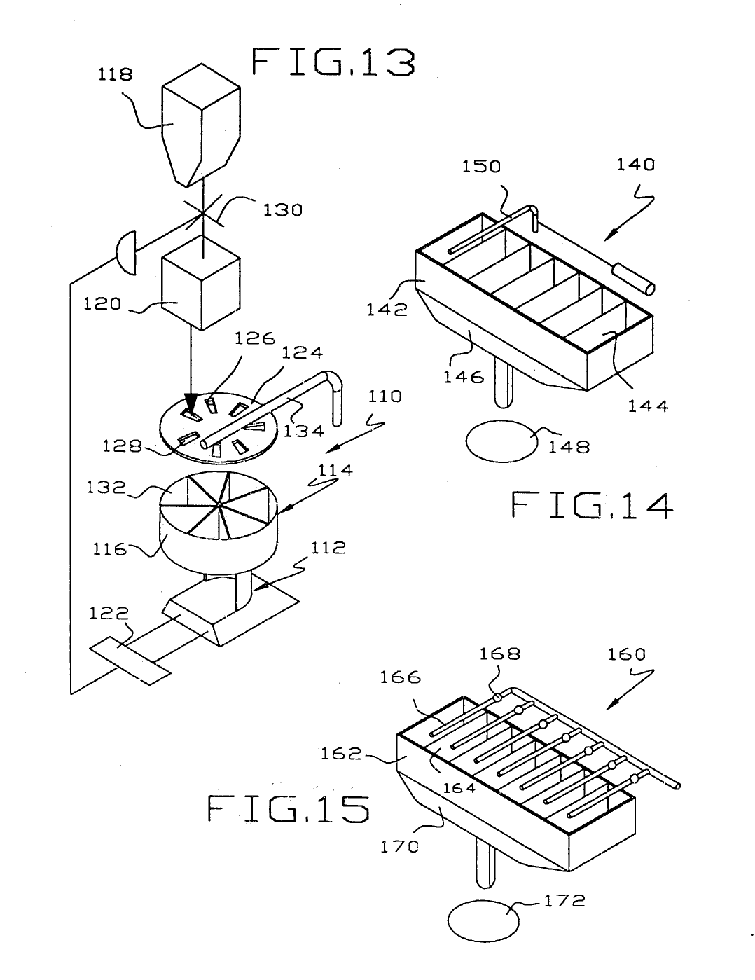

Referring to FIG. 14, another coffee maker 140 of this invention is illustrated. In the embodiments of FIGS. 1-13, the coffee holding tray is moved and the conduit delivering hot water to the coffee holding tray is stationary. It is apparent this relationship may be reversed. To this end, the coffee maker 140 includes a stationary coffee tray 142 having a plurality of compartments 144 for receiving ground coffee. The compartments 144 discharge hot liquid coffee into a manifold 146 above a coffee pot (not shown) on a hot plate 148. A hot water conduit 150 above the tray 142 is movable by a mechanism 152 to position the discharge outlets of the conduit 150 in sequential brewing relation with each of the compartments 144 in response to commands from a control circuit (not shown) as previously described.

Referring to FIG. 15, another coffee maker 160 of this invention is illustrated. A coffee maker 160 of this invention includes a stationary coffee tray 162 having a plurality of compartments 164 and a plurality of hot water conduits 166, each equipped with a valve 168 controlled by a control circuit (not shown). The control circuit independently operates the valves 168 to deliver hot water sequentially to the conduits 166 and thus to the compartments 164. The compartments 164 drain through a manifold 170 into a coffee pot (not shown) on a heated station 172. It will be seen that the coffee maker 160 has the capacity for brewing sequential pots of coffee in response to commands from a control circuit as previously described.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I claim:

1. A coffee maker comprising a source of water; a series of compartments for receiving ground coffee; a station for receiving a coffee pot in brewed coffee receiving relation to the compartments; and a control circuit directing a batch of hot water, sufficient to make one pot of coffee, sequentially to the compartments and thereby delivering a batch of brewed coffee to the coffee pot thereby making multiple sequential pots of coffee.

2. The coffee maker of claim 1 wherein the source of water is stationary and the compartments are movable.

3. The coffee maker of claim 2 wherein the compartments are pie shaped segments of a tray mounted for rotation and the control circuit rotates the tray and thereby positions a different compartment in brewing relation between the source of water and the station.

4. The coffee maker of claim 2 further comprising a storage bin for coffee beans and a coffee mill in bean receiving relation with the storage bin, the coffee mill being stationary and in ground coffee transferring relation to the compartments.

5. The coffee maker of claim 1 wherein the compartments are stationary and the source of water is movable.

6. The coffee maker of claim 1 wherein the source of water comprises an outlet for each of the compartments and further comprising a control circuit for delivering water independently to the outlets.

7. The coffee maker of claim 1 further comprising a sensor at the station for detecting whether a pot therein is at least partially full and disabling the coffee maker if the pot is at least partially full.

8. The coffee maker of claim 7 wherein the station includes a heater for heating a coffee pot at the station.

9. The coffee maker of claim 1 further comprising a closure for the compartments sealing the compartments and an assembly for moving the closure to an open position before the delivery of water to the compartments.

10. The coffee maker of claim 1 further comprising a closure for each of the compartments sealing the compartments and an assembly for moving the closure of a selected one of the compartments to an open position before the delivery of water to the selected compartment.

11. The coffee maker of claim 1 wherein the station includes a thermally conductive plate for supporting the coffee pot and a heating element in heat transferring relation to the plate.

12. The coffee maker of claim 1 wherein the control circuit provides a manual mode of operation, a mode of operation where the coffee maker institutes a brewing cycle at a predetermined time each day for a predetermined number of days, and a constant brew cycle where the coffee maker starts a brewing cycle each time the coffee pot is empty.

13. The coffee maker of claim 12 further comprising a sensor at the station for detecting whether a pot therein is at least partially full and disabling the coffee maker if the pot is at least partially full.

14. The coffee maker of claim 1 wherein the source of water comprises a chamber of a size sufficient to make a pot of coffee with ground coffee from each of the compartments.

15. The coffee maker of claim 1 wherein the source of water comprises a conduit for connection to a source of city water.

16. The coffee maker of claim 1 further comprising a storage bin for coffee beans and a coffee mill in bean receiving relation with the storage bin, the coffee mill being in ground coffee transferring relation to the compartments.

17. A method of operating a coffee maker of the type comprising a source of water, a series of compartments for receiving ground coffee, a station for receiving a coffee pot in brewed coffee receiving relation to the compartments, and a control circuit directing a batch of hot water, sufficient to make one pot of coffee, to the compartments, the method comprising
delivering a first batch of hot water to a first compartment and making a first pot of coffee, and
after the coffee pot is empty, delivering a second batch of hot water to a second compartment and making a second pot of coffee.

18. The method of claim 17 wherein the second pot of coffee is made on a day after the first pot of coffee is made.

19. The method of claim 17 wherein the second pot of coffee is made immediately after the coffee pot is emptied.

20. The method of claim 17 wherein the second pot of coffee is made in response to a command by a user to the control circuit.

21. The method of claim 17 wherein the series of compartments are loaded with ground coffee substantially simultaneously.

22. The method of claim 17 wherein a first compartment is loaded with ground coffee after the first pot of coffee is made and the second pot of coffee is made by delivering water to the first compartment.
